(19) United States
(12) Patent Application Publication
(10) Pub. No.: US 2026/0298203 A1
(43) Pub. Date: Oct. 1, 2026

(54) SEALED DUAL BEARING ENCLOSURE FOR A GENERATOR OF A VERTICAL AXIS WIND TURBINE

(71) Applicant: Kynetic Energy Solutions Inc., St. Malo (CA)

(72) Inventors: Justin Maynard, St. Malo (CA); Maurice Dorge, Winnipeg (CA)

(21) Appl. No.: 19/095,516

(22) Filed: Mar. 31, 2025

(51) Int. Cl. F03D 9/25; F03D 80/70; H02K 5/16; H02K 7/18

(52) U.S. Cl. CPC F03D 9/25; F03D 80/703; H02K 5/165; H02K 7/183; F05B 2220/706; F05B 2240/54; F05B 2260/98

(57) ABSTRACT

A sealed dual bearing enclosure assembly for a generator of a vertical axis wind turbine features an upright spindle holding a stator of the generator at a first elevation below a top end of the spindle, and an outer housing sized and shaped to fit externally around and over the spindle from the top end thereof, and configured to support a rotor of the generator at a second elevation that exceeds the first elevation. Lower and upper bearings are installed between the spindle and housing in an enclosed internal space therebetween. The spindle comprises a first lubrication passage having at least one external port penetrating the spindle exterior outside the outer housing, and an interior port that opens into the enclosed internal space between the spindle and the outer housing. This lubricated dual bearing enclosure of sealed and easily serviceable design increases the overall service life of the turbine.

### FIELD OF THE INVENTION

This application relates generally to the field of wind turbines, and more specifically relates to an improved bearing setup for a generator of a vertical axis wind turbine.

### BACKGROUND

The present invention concerns a type of vertical axis wind turbine (VAWT) in which the generator is mounted on an upright support mast, and in which support arms of the turbines wind-driven blades are attached directly to an annular magnet-carrying upper rotor of the generator, which lies in overhead and rotating relation to an annular coil-carrying stator statically mounted on the mast. This denoted a departure from more conventional VAWT designs where the blades were mounted to a central driveshaft upstanding from the top of the generator and connected to the rotor thereof. A prior example of the concerned type of VAWT can be seen, for example, in FIG. 5A of Published US Patent Application 2009/0140528 by Ireland, in which purported benefits of the change included the omission of potentially catastrophic torque loads.

However, in experiment with prior VAWTs of this type, Applicant has found that the effective lifespan of the generator was perhaps most critically limited by the service life of the installed bearings thereof, which are necessary to accommodate the relative rotation between the generator components. Service of individual bearings via grease zerks proved ineffective to overcome the limited lifespan, as did attempts to solve the problem with installation of a supplemental external greasing system, at notable expense.

Accordingly, there is a need for notable improvement to the bearing setup in a VAWT generator of the forgoing type in order alleviate or overcome the shortcomings of the prior art.

### SUMMARY OF THE INVENTION

According to a first aspect of the invention, there is provided a sealed dual bearing enclosure assembly for a generator of a vertical axis wind turbine having a stator equipped with magnetic field coils, a magnet carrying rotor for rotational movement over the stator to generate electric current in the field coils, and wind-driven blades coupled to said rotor to drive said rotational movement thereof during exposure of said wind-driven blades to moving air currents, said assembly comprising:
a spindle having an upright central axis, and being configured to support said stator on said spindle at a first elevation thereon spaced vertically below a top end of said spindle;
an outer housing sized and shaped to fit externally around and over said spindle from the top end thereof, and being configured to support said rotor on said outer housing at a second elevation thereon of upwardly spaced relation to said first elevation; and
a lower bearing and an upper bearing, both operably installed between said spindle and said outer housing in an enclosed and sealed internal space therebetween to enable relative rotation of the outer housing around said spindle, of which said lower bearing resides at a lesser elevation nearer to the first elevation and the upper bearing resides at a greater elevation nearer to the top end of the spindle;
wherein the spindle comprises a first lubrication passage having at least one external port that penetrates an exterior of the spindle at a location outside the outer housing, and an interior port that opens into the enclosed internal space between the spindle and the outer housing.

According to another aspect of the invention, there is provided a vertical axis wind turbine comprising:
a stator equipped with magnetic field coils;
a magnet-carrying rotor for rotational movement over the stator in closely neighbouring relation thereto to generate electric current in the field coils;
wind-driven blades coupled to said rotor to drive said rotational movement thereof during exposure of said wind-driven blades to moving air currents; and
the sealed dual bearing assembly according to the preceding first aspect of the invention;
wherein the stator is supported on the spindle at the first elevation thereon, and the rotor is supported on the outer housing at said second elevation thereon for rotation therewith about the upright central axis of the spindle under driven rotation of the blades by moving air currents.

### BRIEF DESCRIPTION OF THE DRAWINGS

One embodiment of the invention will now be described in conjunction with the accompanying drawings in which:

FIG. 1 is a side elevational view of a vertical axis wind turbine (VAWT) whose generator features a sealed dual bearing enclosure according to the present invention.

FIG. 2 is a side elevational view of the generator of FIG. 1.

FIG. 3 is a top perspective view of the generator of FIG. 2.

FIG. 4 is a bottom perspective view of the generator of FIG. 2.

FIG. 5 is a top plan view of the generator of FIG. 2.

FIG. 6 is a bottom plan view of the generator of FIG. 2.

FIG. 7 is a cross-sectional view of the generator of FIG. 6, as cross-sectioned in a vertical plane denoted by line A – A of FIG. 6.

FIG. 8 is a top perspective view of the generator of FIG. 2 with a rotor thereof removed for illustrative purpose.

FIG. 9 is a bottom perspective view of the removed rotor, in isolation.

FIG. 10 is a top perspective view of a stator plate of the generator, in isolation.

FIG. 11 is an isolated top perspective view of a spindle of the generator’s sealed dual bearing enclosure.

### DETAILED DESCRIPTION

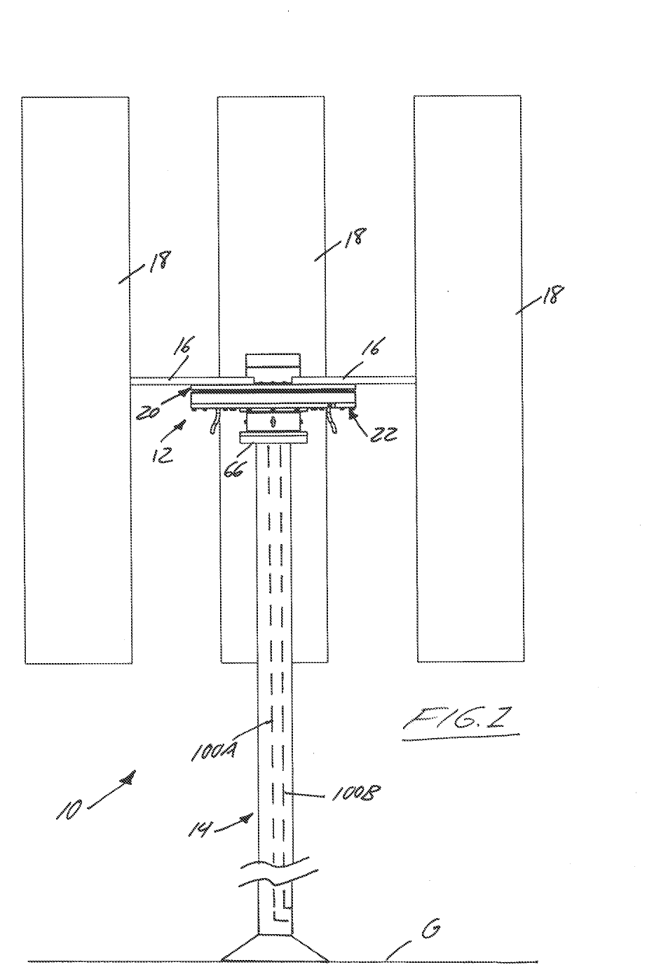

FIG. 1 illustrates a vertical axis wind turbine (VAWT) 10 of the present invention, which is of the aforementioned type in which the generator 12 is mounted on an upright support mast 14, and in which support arms 16 of the turbine’s wind-driven blades 18 (shown schematically, without detail) are attached directly to an annular magnet-carrying upper rotor 20 of the generator 12. The upper rotor 20 lies in overhead and rotating relation to an underlying annular coil-carrying stator 22 that is statically mounted on the support mast 14. The present invention addresses the aforementioned shortcomings of the prior designs, via modification of the prior generator designs to include a lubricated dual bearing enclosure of sealed and easily serviceable design, of which the details of one preferred embodiment are set forth herein as follows.

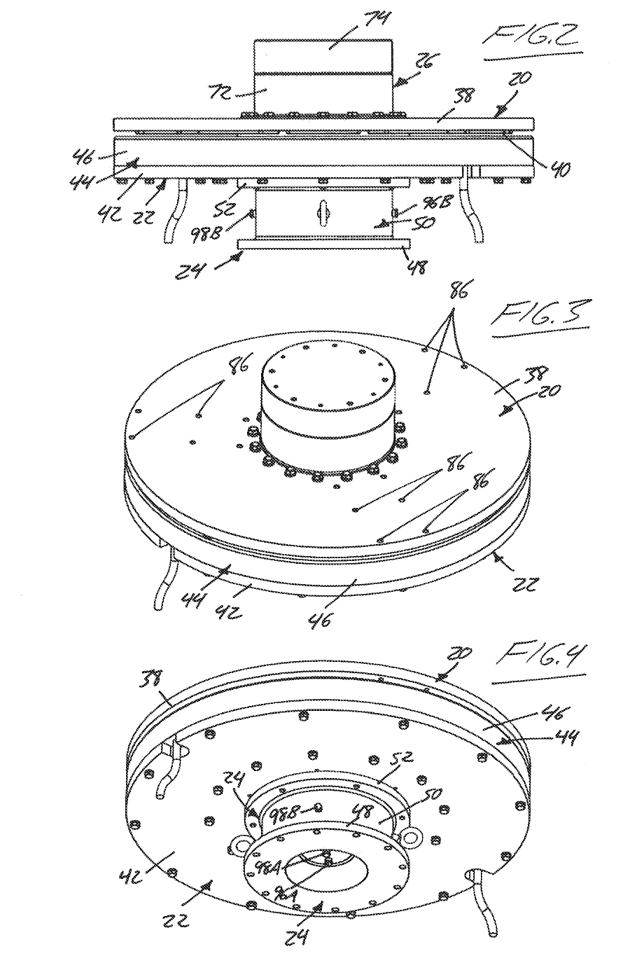

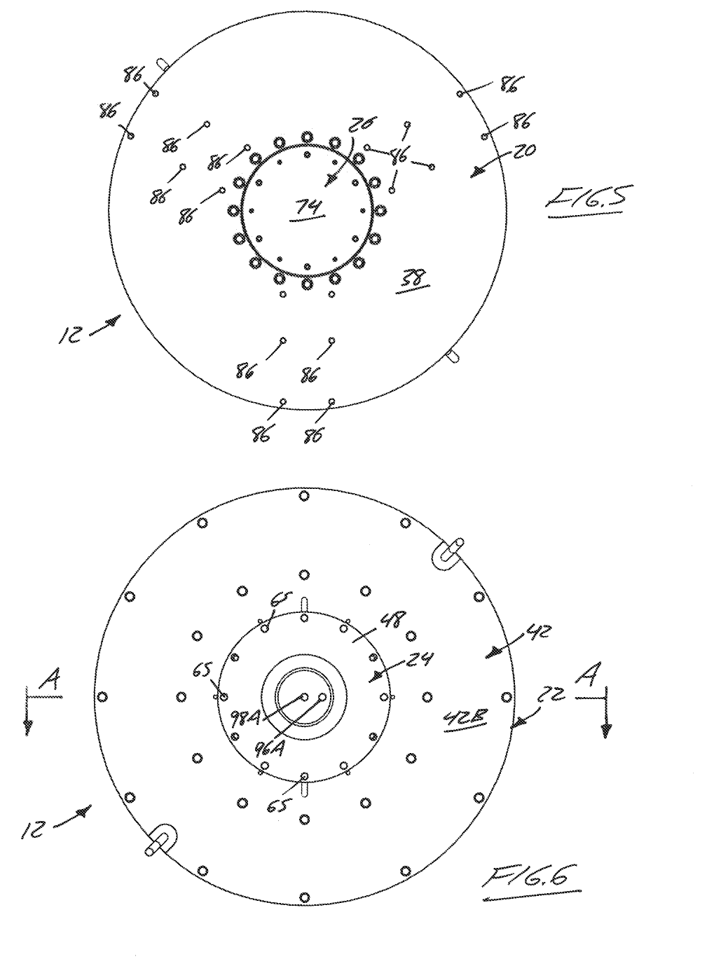

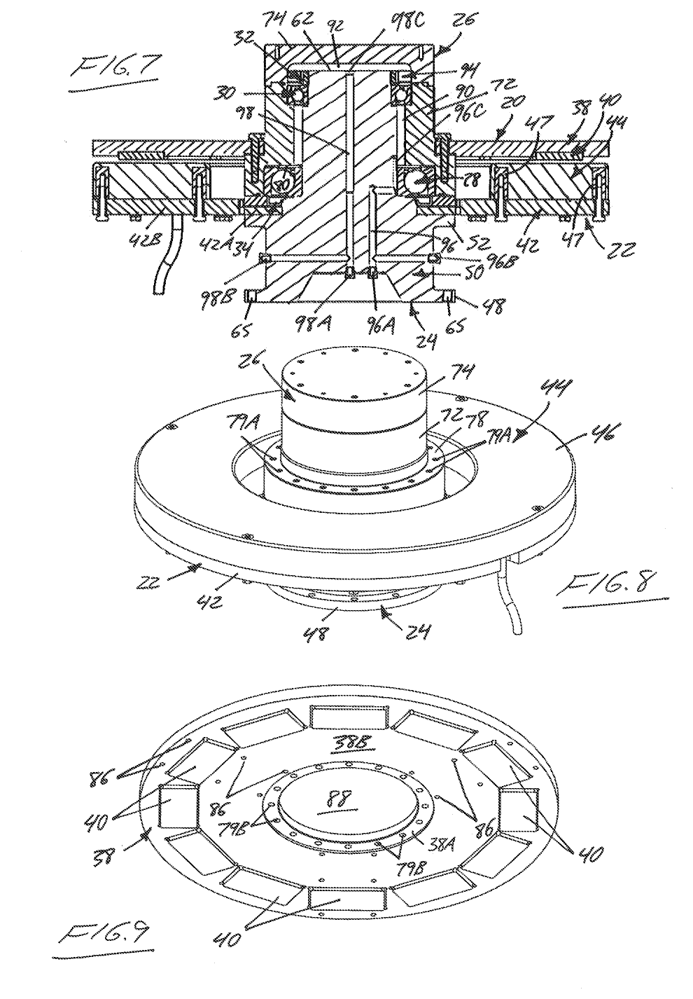

The enclosed dual bearing assembly features a central spindle 24, an outer housing 26, a lower bearing 28, an upper bearing 30, a retaining nut 32, and an oil seal 34, of which only parts of the spindle 24 and outer housing 26 are visible in the assembled state and non-sectioned views FIGS. 1-6 and 8. The internal components, including the lower bearing 28, upper bearing 30, retaining nut 32 and oil seal 34, are best revealed in the cross-sectional view of FIG. 7. In addition to the bearing assembly, the generator includes the aforementioned upper rotor 20 and underlying stator 22. The bearings 28, 30 preferably include both a radial bearing and a thrust bearing, of which in one particular embodiment, the thrust bearing is the lower bearing and the radial bearing is the upper bearing.

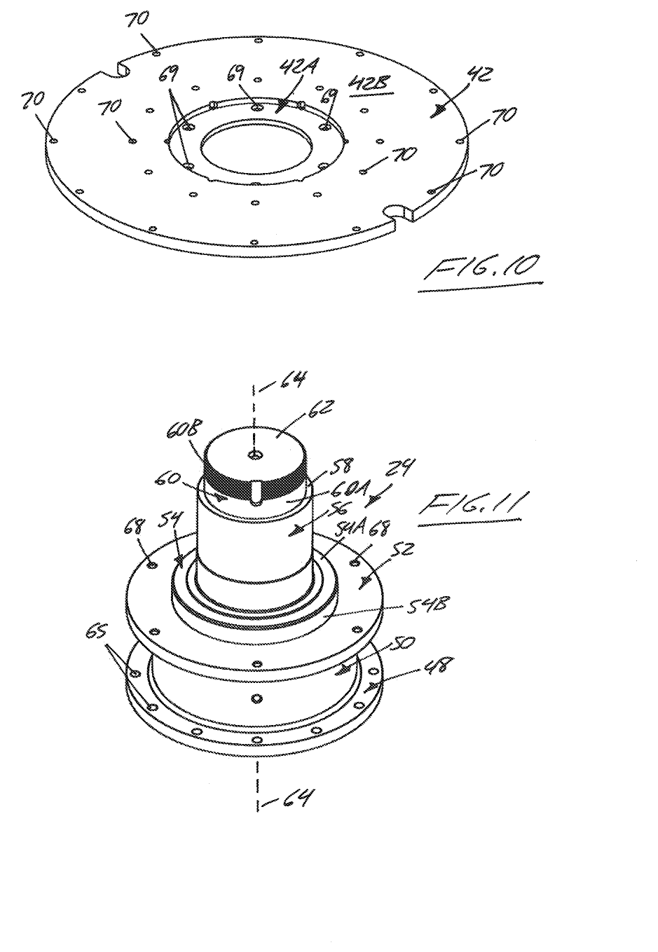

The rotor 20, shown in solation in FIG. 9, is composed of an annular rotor plate 38, on an underside of which there are carried a plurality of permanent magnets 40 arrayed circumferentially around the annular rotor plate 38 near the outer circumference thereof. The stator 22, best revealed in FIG. 8 by removal of the overlying rotor 20, likewise feature an annular stator plate 42, atop which there is carried an encased field coil unit 44 of annular shape spanning circumferentially around a central opening of the annular stator plate 42. This field coil unit 44 contains therein a plurality of field coils wound around a ring-shaped core, the combination of which is subsequently encased in a protective outer coating 46 during production of the field coil unit 44. For illustration of such wrapping of field coil windings around a ring-shaped core, see for example FIGS. 1A & 1B of Published US Patent Application US20130009406 by Ireland. Also encased within the outer protective coating 46, together with the ring-shaped core and field windings wound thereon, are a plurality of hold downs 47, by which the field coil unit 44 is bolted to the underlying stator plate 42 from the underside thereof at spaced intervals therearound near the inner and outer perimeters of the annular field coil unit 44.

The spindle 24 is shown in isolation in FIG. 11, and features, starting from a bottom end thereof and moving upward, a circular mounting flange 48, a cylindrical base neck 50 of slightly lesser outer diameter than the underlying mounting flange 48, a circular stator support flange 52 of greater outer diameter than the underlying base neck 50, a lower bearing support shoulder 54 of lesser outer diameter than the underlying stator support flange 52, a cylindrical core 56 of lesser outer diameter than the underlying lower bearing support shoulder 54, an upper bearing support shoulder 58 that cuts radially inward from the top end of the cylindrical core 56, and a cylindrical upper terminus 60 that stands upright from the upper bearing support shoulder 58. The lower bearing support shoulder 54 juts radially outward from the bottom end of the cylindrical core 56. The cylindrical upper terminus 60 is of stepped down diameter from the cylindrical core 56, hence creating the upper bearing support shoulder 58. The cylindrical upper terminus 60 terminates at its top end with a flat upper face 62 that denotes a top end of the overall spindle 24. The forgoing features of the spindle 24 are all centered on a shared upright central axis 64, which resides in a vertical orientation in an installed working position of the generator in the assembled and erected VAWT, and therein coincides with a rotational axis of the VAWT about which the wind-driven blades 18 revolve, which also coincides with a central longitudinal axis of the support mast 14.

The mounting flange 48 at the bottom end of the spindle 24 has a plurality of bolt holes 65 penetrating vertically therethrough at circumferentially spaced positions around the mounting flange 48. This enables bolted mounting of the spindle 24 to a corresponding flange seat 66 at the top end of the support mast 14, which has a matching set of bolt holes therein to enable such bolted attachment of the spindle 24 thereto. The stator support flange 52 likewise has a plurality of bolt holes 68 penetrating vertically therethrough at circumferentially spaced positions around the stator support flange 52. This enables bolted mounting of the stator plate 42 atop the stator support flange 52 via a matching set of bolt holes 69 in an inner marginal area 42A of the annular stator plate 42 near the central hole thereof. At this inner marginal area 42A of the annular stator plate 42, the top surface of the annular stator plate 42 is of downwardly recessed relation relative to a surrounding majority area 42B of the annular stator plate, which spans radially outward from the inner marginal area 42A to the outer perimeter of the annular stator plate 42. The annular field coil unit 44 sits atop the more elevated topside of this majority area 42B of the stator plate 42, in which there are arrayed a plurality of vertically penetrating bolt holes 70 of matching layout to the hold downs 47 of the field coil unit. This enables the bolted attachment of the field coil unit 44 to the topside of the stator plate 42 from the opposing underside thereof.

The outer housing 26 fits externally over and around the cylindrical core 56 and upper terminus 60 of the spindle 24. In the illustrated example, the outer housing is composed of a main body 72 that circumferentially surrounds the cylindrical core 56 of the spindle 24, a circular upper cap 74 that is bolted to an annular top end of the main body 72 in a position spanning overtop of the spindle’s top end 62, and an annular seal ring 76 that is bolted to an annular bottom end of the main body 72 in a position overlying the inner marginal area 42A of the annular stator plate, which in turn is seated atop, and bolted to, the stator support flange 52 of the spindle. The annular bottom end of the housing’s main body 72 is of greater inner and outer diameter than the annular top end thereof. An exterior of the housing’s main body 72 features a rotor support shoulder 78 (FIG. 8) at which the outer diameter of the main body 72 transitions from a lesser diameter at an upper portion of the main body 72 to a greater diameter at a lower portion of the main body. An inner marginal area 38A of the rotor plate 38 is seated atop, and bolted onto, this external rotor support shoulder 78 of the outer housing 26 using aligned bolt holes 79A, 79B in the rotor support shoulder 78 and the inner marginal area 38A of the rotor plate 38. The interior of the housing’s main body 72 is of similarly stepped configuration to the exterior thereof, thus having an internal shoulder 80 at which the inner diameter of the main body 72 transitions from a lesser diameter at the upper portion of the main body to a greater diameter at the lower portion of the main body.

The lower bearing 28 is seated atop an annular top face 54A of the spindle’s lower bearing support shoulder 54, and resides beneath the internal shoulder 80 of the housing 26. An inner race of the lower bearing 28 is engaged around the cylindrical core 56 of the spindle 24, while the outer race of the lower bearing 28 is engaged against the inner wall of the lower portion of the housing’s main body 72. The oil seal 34 is installed beneath the lower bearing 28 and atop the inner marginal area 42A of the stator plate 42, and thus resides in an annular space left between the bottom seal ring 76 of the housing 26 and an outer wall 54B of the spindle’s lower bearing support shoulder 54. The upper bearing 30 is seated atop the upper bearing support shoulder 58 of the spindle 24. An inner race of the upper bearing 30 is engaged around a smooth-walled lower portion 60A of the spindle’s cylindrical upper terminus 60, while the outer race of the upper bearing 30 engaged against the inner wall of the upper portion of the housing’s main body 72. Above the smooth walled lower portion 60A of the spindle’s cylindrical upper terminus 60, a remaining upper portion 60B thereof at the top end of the spindle 24 is externally threaded. It is to this threaded upper portion 60B that the internally threaded retaining nut 32 is threaded onto the spindle 24 in order to axially capture the upper bearing 30 between the tightened retaining nut 32 and the underlying upper bearing support shoulder 58 of the spindle 24.

The spindle 24, outer housing 26, lower and upper bearings 28, 30, and annular rotor and stator plates 38, 42 all reside in concentric relation to one another, centered on the upright central axis 64 of the spindle. The lower and upper bearings 28, 30 thus hold the main body 72 of the outer housing 26 in concentrically surrounding and rotatable relation to the core and upper terminus 56, 60 of the spindle 24. The magnets 40 on the rotor plate 38, which is bolted onto to the rotatable outer housing 26 at the rotor support shoulder 78 thereof for rotation therewith, reside in closely overlying relation to the annular field coil unit 44 on the underlying stator plate 42. The smaller diameter upper portion of the housing’s main body 72 spans upwardly through the central hole 88 of the rotor plate 38, whereby the capped off top end of the outer housing 26 defines the terminal uppermost end of the assembled generator 12. At the underside of the rotor plate 38, the bottom surface thereof at the inner marginal area 38A is of upwardly recessed relation from the remainder of bottom surface that occupies the surrounding majority area 38B of the rotor plate 38, which spans radially outward from the inner marginal area 38A to the outer perimeter of the rotor plate 38B.

It is to an outer region of this surrounding majority area 38B of the rotor plate 38 that the arrayed magnets 40 are secured. Among the circularly arrayed magnets 40 on the rotor plate 38, each adjacent pair of magnets are of inverted relationship to another, so that each magnet whose northern pole faces downward and southern pole face upward is neighboured on either side by a magnet whose southern pole faces downward and northern pole faces upward, and vice versa. Accordingly, during rotation of the outer housing 26 and attached rotor plate 38, the magnets 40 are moved through a revolutionary path around the central axis 64 in close proximity overtop of the field coil unit 44, thus generating current within the field coils thereof, as is well known to those of skill in the art. The rotor plate 38 has arrayed therein sets of blade support bolt holes 86, by which the blade support arms 16 of the VAWT’s wind-driven blades 18 are secured in bolted attachment to the topside of the rotor plate 38 at positions of equal angular spacing to one another around the shared central axis 64 of the generator components. Accordingly, wind-driven movement of the VAWT blades 18 drives rotational movement of the rotor 20, and thereby generates electrical current within the field coils of the generator 12.

Referring to FIG. 7, an annular lower gap space 90 exists between the cylindrical exterior of the spindle’s core 56 and the cylindrical interior of the housing’s main body 72. This annular gap space 90 occupies an elevational range bound between the lower bearing 28 and the upper bearing 30. A circular upper gap space 92 also exists between the spindle 24 and the upper cap 74 of the outer housing 26 at the top end 62 of the spindle 24, and thus resides above the upper bearing 30 and around the retaining nut 32. These two gap spaces 90, 92 form respective parts of an overall interior space 94 of the dual bearing assembly. This interior space 94 is delimited between the spindle 24 and outer housing 26, and contains both the lower bearing 28 and upper bearing 30. In terms of its elevational span, a bottom end of this interior space 94 is denoted by the seal ring 76 and the neighbouring oil seal 34 that reside at the bottom end of the housing 26 and atop the inner marginal area 42A of the stator plate 42. An opposing top end of the interior space 94 is denoted by the underside of the outer housing’s upper cap 74. This interior space 94 is a sealed enclosure, being sealed closed at the bottom end by the oil seal 34 that resides beneath the lower bearing 28, and inside the seal ring 76 of the rotatable outer housing. To enable filling and drainage of this interior space 94 with a lubricating oil in order to maximize the attainable overall service life of the lower and upper bearings 28, 30, the spindle 24 is equipped with at least one lubrication passage.

Mores specifically, the preferred embodiment shown in the drawings has two such lubrication passages 96, 98. Each lubrication passage 96, 98 has two external ports that penetrate an exterior of the spindle 24 at locations that are situated outside of the bearing assembly’s interior space 94, at positions situated below, and unconcealed by, each of the outer housing 26, the stator 22 and the rotor 20. The external ports of the first lubrication passage 96 include an external bottom port 96A penetrating the exterior of the spindle 24 at an underside thereof near, but preferably elevated from, the mounting flange 48, and an external side port 96B penetrating the exterior spindle 24 at an outer peripheral side of the base neck 50. The first lubrication passage 96 also has an interior port 96C that opens into the interior space 94 of the bearing assembly at an outer peripheral side of the spindle’s cylindrical core 56, and at a position residing beside the inner race of the lower bearing 28. In the illustrated example, this interior port 96C of the first lubrication passage 96 is slot-shaped, and is orientated with its elongation lying axially of the spindle 24. The axial length of this slot-shaped interior port 96C exceeds the axial thickness of the lower bearing 28, and spans from a bottom plane of the lower bearing 28 past a top plane thereof and into the annular lower gap space 90 of the bearing assembly interior. Accordingly, pumping of lubricating oil into the interior space 94 of the bearing assembly through this first lubrication passage 96 from either of the two exterior ports 96A, 96B thereof is operable to both lubricate the lower bearing 28, and fill the annular lower gap space 90 above the lower bearing 28.

The external ports of the second lubrication passage 98 include an external bottom port 98A penetrating the exterior of the spindle 24 at an undersurface thereof, for example a same upwardly recessed surface of the spindle’s underside that is also occupied by the external bottom port 96A of the first lubrication passage; and an external side port 98B penetrating the exterior spindle 24 at an outer peripheral surface of the base neck 50, for example at a diametrically opposing side thereof from the external side port 96B of the first lubrication passage 96. The second lubrication passage 96 also has an interior port 98C that opens into the interior space 94 of the bearing assembly, but this time at the top end 62 of the spindle 24. In the illustrated example, the external bottom port 98A and top interior port 98C of the second lubrication passage 98 both reside on the central upright axis 64 of the spindle, at opposite ends of a linear main segment of the lubrication passage, a remainder of which is composed of a radial branch that spans radially outward from this main axial segment to the external side port 98B. Each external port of each lubrication passage features either a removable plug by which the port is selectively openable for filling or drainage, or a hose fitting to which an external hose is connectable to form a lubrication service conduit through which lubricating oil can be drained or filled.

While other embodiments may alternatively feature only a singular lubrication passage, one notable benefit of the multi-passage design of the illustrated embodiment is that one passage can be used to introduce lubricating oil into the enclosure during a filling process, during which the other passage is used for level checking purposes to determine when the interior space of the bearing assembly has been filled to a substantially “full” level. In a preferred method, lubricating oil is pumped into the interior of the bearing assembly through the first lubrication passage 96 using a selected one of the exterior ports 96A, 96B thereof, whereby the introduced lubricating oil directly lubricates the lower bearing 28 and gradually fills the interior space 94 from the bottom up. Once the oil has completely filled the annular gap space 90, it reaches and lubricates the upper bearing 30, and with continued filling, the oil level rises up past the upper bearing 30 into the upper gap space 92, thus achieving a substantially “full” state of the bearing assembly interior, where both bearings 28, 30 are immersed within oil. Here, the oil in the upper gap space 92 starts draining down into the second lubrication passage 98 via the interior port 98C thereof at the top end 62 of the spindle 24, whereby appearance of such draining oil at either of the exterior ports 98A, 98B of the second lubrication passage 98, or at the far end of a service hose connected thereto, informs service personnel that a full state of the bearing assembly interior has been achieved, whereupon pumped introduction of the lubricating oil can be terminated.

Referring to FIG. 1, the inclusion of external bottom ports 96A, 98A is particularly beneficial for hidden routing of connected service hoses 100A, 100B from the underside of the spindle 24 at the bottom of the generator 12 down through a hollow interior of the support mast 14 toward ground level G, whereby the bearing assembly of an erected VAWT can be serviced remotely from at or near ground level G without having to either remove the generator 12 from its installed position atop the support mast 14, or somehow gain elevated worker access to the generator’s installed and elevated position atop the support mast 14. That being said, the exterior side ports 96B, 98B could alternatively be used to connect such service hoses 100A, 100B, which may alternative be routed externally down the support mast 14, or routed into the support mast interior via suitable hosing ports provided therein. However, the inclusion of exterior bottom ports 96A, 96B enables the cleanest install of such service hoses 100A, 100B in fully concealed, and optically protected, fashion.

The additional, but optional, inclusion of the exterior side ports 96B, 98B is nonetheless also beneficial, even if unused in the installed position of the generator 12, for example to enable easier side access to the lubrication passages 96, 98 in other scenarios, such as initial on-site filling of the generator at ground level before final erection of the VAWT, or in off-site testing or service scenarios. In addition to enabling drainage and filling from at or near ground level, the service hoses 100A, 100B also enable installation of oil-level indication or checking equipment at or near ground level, optionally with powered/automated oil top-up/filling equipment. Regardless, even in the absence of service hoses enabling lubrication service from a remote elevation at or nearer to ground level, the novel design of the sealed, lubricated, dual-bearing enclosure offers a significant improvement over the bearing setups of the prior art for an improved service life of the VAWT turbine 12.

Since various modifications can be made in my invention as herein above described, and many apparently widely different embodiments of same made, it is intended that all matter contained in the accompanying specification shall be interpreted as illustrative only and not in a limiting sense.

1. A sealed dual bearing enclosure assembly for a generator of a vertical axis wind turbine having a stator equipped with magnetic field coils, a magnet carrying rotor for rotational movement over the stator to generate electric current in the field coils, and wind-driven blades coupled to said rotor to drive said rotational movement thereof during exposure of said wind-driven blades to moving air currents, said assembly comprising:
a spindle having an upright central axis, and being configured to support said stator on said spindle at a first elevation thereon spaced vertically below a top end of said spindle;
an outer housing sized and shaped to fit externally around and over said spindle from the top end thereof, and being configured to support said rotor on said outer housing at a second elevation thereon of upwardly spaced relation to said first elevation; and
a lower bearing and an upper bearing, both operably installed between said spindle and said outer housing in an enclosed internal space therebetween to enable relative rotation of the outer housing around said spindle, of which said first lower bearing resides at a lesser elevation nearer to the first elevation and the upper bearing resides at a greater elevation nearer to the top end of the spindle;
wherein the spindle comprises a first lubrication passage having at least one external port that penetrates an exterior of the spindle at a location outside the outer housing, and an interior port that opens into the enclosed internal space between the spindle and the outer housing.

2. The assembly of claim 1 wherein the spindle comprises an external stator support flange at the first elevation to support the stator atop said stator support flange.

3. The assembly of claim 1 wherein the outer housing comprises an external rotor support shoulder at the second elevation to support the rotor atop said rotor support shoulder.

4. The assembly of claim 3 wherein the external rotor support shoulder neighbours an internal shoulder of the outer housing, and said internal shoulder overlies the lower bearing.

5. The assembly of claim 1 wherein the spindle has an exterior shoulder at the greater elevation thereon to support the upper bearing atop said exterior shoulder.

6. The assembly of claim 1 wherein the spindle comprises external threading at an upper portion thereof above the upper bearing, and the assembly further comprises an internally threaded retention nut for threaded engagement with the spindle at said upper portion in an installed position overlying said upper bearing.

7. The assembly of claim 1 wherein the at least one external port of the first lubrication passage comprises two external ports thereof.

8. The assembly of claim 7 wherein said two external ports of the first lubrication passage include a side port of the first lubrication passage that penetrates the exterior of the spindle at a peripheral side thereof that faces outwardly away from the central upright axis.

9. The assembly of claim 7 wherein said two external ports of the first lubrication passage include a bottom port of the first lubrication passage that penetrates the exterior of the spindle at an underside thereof that faces downwardly along the central upright axis.

10. The assembly of claim 1 wherein the spindle further comprises a second lubrication passage having at least one additional external port that penetrates the exterior of the spindle at another location outside the outer housing, and another interior port that opens into the enclosed internal space between the spindle and the outer housing.

11. The assembly of claim 10 wherein the at least one additional external port of the second lubrication passage comprises two external ports thereof.

12. The assembly of claim 11 wherein said two external ports of the second lubrication passage include a side port of the second lubrication passage that penetrates the exterior of the spindle at a peripheral surface thereof that faces outwardly away from the central upright axis.

13. The assembly of claim 11 wherein said two external ports of the second lubrication passage include a bottom port of the second lubrication passage that penetrates the exterior of the spindle at an undersurface thereof that faces downwardly along the central upright axis.

14. The assembly of claim 10 wherein, of the first and second lubrication passages, the interior port of the second lubrication passage resides at a higher elevation than the interior port of the first lubrication passage.

15. The assembly of claim 14 wherein the interior port of the second lubrication passage resides above the upper bearing.

16. The assembly of claim 14 wherein the interior port of the second lubrication passage resides at the top end of the spindle.

17. The assembly of claim 10 comprising a first service conduit connected to one of the at least one external ports of the first lubrication passage, and a second service conduit connected to one of the at least one external ports of the second lubrication passage, of which said first and second service conduits are both positioned or positionable to run down along a support mast of the wind turbine to enable lubrication service of the assembly from at or near ground level.

18. The assembly of claim 1 further comprising a first elongated service conduit connected to one of the at least one external ports of the first lubrication passage, and positioned or positionable to run down along a support mast of the wind turbine to enable lubrication service of the assembly from at or near ground level.

19. The assembly of claim 1 wherein the interior port of the first lubrication passage resides at an elevation nearer to the lower bearing than to the upper bearing.

20. A vertical axis wind turbine comprising:
a stator equipped with magnetic field coils;
a magnet-carrying rotor for rotational movement over the stator in closely neighbouring relation thereto to generate electric current in the field coils;
wind-driven blades coupled to said rotor to drive said rotational movement thereof during exposure of said wind-driven blades to moving air currents; and
the sealed dual bearing assembly of any preceding claim 1-19;
wherein the stator is supported on the spindle at the first elevation thereon, and the rotor is supported on the outer housing at said second elevation thereon for rotation therewith about the upright central axis of the spindle under driven rotation of the blades by moving air currents.
